(19) United States
(12) Patent Application Publication
(10) Pub. No.: US 2008/0270467 A1
(43) Pub. Date: Oct. 30, 2008

(54) METHOD AND SYSTEM FOR CONDUCTING A REMOTE EMPLOYMENT VIDEO INTERVIEW

(75) Inventor: Spencer Roy Clarke, Amissville, VA (US)

Correspondence Address: STITES & HARBISON PLLC, 1199 NORTH FAIRFAX STREET, SUITE 900, ALEXANDRIA, VA, 22314, US

(73) Assignee: S.R. CLARKE, INC., Fairfax, VA (US)

(21) Appl. No.: 11/739,357

(22) Filed: Apr. 24, 2007

(51) Int. Cl. G06F 7/00

(52) U.S. Cl. 707/104.1

(57) ABSTRACT

A method and system is provided for conducting a remote employment video interview. The method includes allowing a candidate to access a remote server and selecting a position for which the candidate wishes to apply. The candidate is presented with questions to which the candidate responds, using a camera and microphone of a telecommunications device, such as a computer or other suitable device. The candidate can review, re-record or accept a response. Advantageously, accepting a response results in the candidate being presented with a next question. This procedure continues until the candidate has responded to all questions. Optionally, the candidate may submit a resume. The responses are uploaded to a server and the employer which the candidate has selected is provided with a reference link, via email, corresponding to a location on the server where the candidate's responses are stored. The employer uses the reference link to access the video interview in the form of either streaming video or, optionally, as a multimedia file, after proper authentication.

### FIELD OF THE INVENTION

The present invention relates to a method and system for conducting a video interview and, in particular, a method and system for conducting a remote employment video interview stored and maintained on a third-party server.

### BACKGROUND OF THE INVENTION

Employment interviews are usually conducted during the employment hiring process. Traditionally, the employment interview is conducted between a prospective employer and a potential employee or candidate for employment (hereinafter referred to as a “candidate”). In the conventional interviewing process, a candidate is interviewed directly by the employer either face-to-face or possibly by telephone. If an employment recruiter is involved in the hiring process, the recruiter may conduct a pre-screening interview with the candidate, which may also be either in person or over the telephone, prior to the candidate meeting with the employer for a subsequent face-to-face or telephone interview.

Typically, when a recruiter is involved in the hiring process, the recruiter screens or pre-selects candidates. The recruiter will then forward candidate information to one or more potential employers selected by the recruiter. The employers may include one or more employers not selected by the candidate. Next, the employer will conduct an interview itself with the candidate. Therefore, if a recruiter is involved in the employment process, the candidate must first be screened by the recruiter.

One recent development in candidate interviewing is to conduct asynchronous audio and/or video interviewing in which a candidate responds to pre-recorded audio or video questions from a recruiter or potential employer. In the case of a recruiter implemented system, the system matches candidate qualification data with requirements from one or more employers, and then the system pushes the candidates' video and audio responses to one or more selected employers. One disadvantage with the prior video interviewing system is that it is employer or recruiter centric and, therefore, provides a candidate with minimal control over the hiring process, in general, and the video interview process, in particular. For example, a candidate cannot specifically select from which employer or position to apply. Further, the prior video interview system is not specifically tailored to optimize newly developed technologies, such as videoconferencing, which is highly variable, i.e. not uniformly implemented and may require direction, configuration and/or assistance in order to adequately prepare a good, professional quality video interview.

### SUMMARY OF THE INVENTION

The present invention relates to a method and system for conducting employment video interviews at a remote location. The system includes a server side and a remote client side. The server side includes a server for storing a database of job listings from various employers and a database for storing data for candidates with their associated employment data. Advantageously, the server is maintained by a third-party, either an employment recruiter or an independent entity, separate from the employers. The job listings include one or more questions for a candidate to answer during a video interview. The client side of the present system includes a candidate interface for a candidate to use during the interviewing process and an employer interface for the employer to view the completed interview. The client interface may include a computer or other video and audio telecommunication device acting as the client interface, operatively associated with the server for the candidate to use when responding to the questions. The client interface is used by the candidate and includes a video camera, microphone, computer screen and speakers, along with an input device for the candidate to use to set up and participate during the video interview.

In use, a candidate uses the client interface to access a third-party server, using an appropriate authentication protocol and, once authenticated, to select one or more positions of which to apply. The candidate is then presented with questions associated with the job to which the candidate is applying. The candidate responds to each question, one at a time, which is recorded using the video camera and microphone. After each response has been made, the candidate can review the response, re-record the response, or accept the response. Accepting the response results in the candidate being presented with the next question. Each recorded response can either be uploaded from the client interface to the server upon the candidate accepting each response, or all responses may be uploaded at the conclusion of the interview. The question/response procedure is repeated until all questions have been presented and answered by the candidate. The candidate can optionally submit a resume or other data, which the candidate wishes to include with his or her responses to the interview questions.

Once the video interview has been submitted, the employer to which the candidate has applied is sent an email with a hyperlink reference or address, back to the server corresponding to a location in the candidate database where the candidate's responses to the interview question, along with a resume or other candidate data are stored. In order to access the candidate's data on the third-party server, the employer uses the hyperlink and an appropriate authentication protocol, such as username and password. Subsequently, the employer is then presented with the video interview in the form of streaming video or, optionally, as a multimedia file.

The present invention, in one form, relates to a method for conducting an interview with a candidate for employment. The method includes creating a database comprising one or more employment positions for one or more employers on a third-party server and allowing a candidate to select an employment position of which to apply. The candidate is then provided, via a computer network, with one or more questions, stored on the third-party server, to which a candidate responds, one question at a time, pertaining to the position selected by the candidate. Next, the candidate is allowed to respond to each question, one at a time, as a video and audio response, and a candidate may review, re-record, delete and accept the prior response before being presented with a next question. All responses are uploaded and stored on the third-party server. The candidate is presented with an option of submitting his or her resume to be associated with the responses and stored on the third-party server. A reference link is forwarded, via email, to the employer whose employment position was selected by the candidate. The reference link corresponds to a location on the third-party server where the candidate's responses and optional resume is stored. The employer is permitted to access the third-party server via an appropriate authentication or security protocol, using the reference link to view a candidate's responses and optional resume. Preferably, the responses are sent to the employer as streaming video and audio or, alternatively, as a multimedia file.

The present invention, in another form thereof, relates to a system for conducting an interview with a candidate for employment. The system includes a third-party server, an employment database, a candidate database, a candidate interface, and an employer interface. The employment database is maintained on a third-party server and includes one or more employment positions for one or more employers, and one or more interview questions associated with a respective employment position. The candidate database is also maintained on the third-party server for storing candidate data comprising candidate responses to the employment questions and an optional resume.

The candidate interface is operatively associated with the third-party server. The candidate interface includes a camera and microphone for recording video and audio. The candidate interface allows the candidate to select one or more employment positions from which to apply, and presents the candidate, via a computer network, with one or more questions, stored on the third-party server, for which the candidate responds, one question at a time, pertaining to the position selected by the candidate, (3) allowing the candidate to respond to each question, one at a time, as a video and audio response, (4) allowing the candidate to review, re-record, delete and accept the prior response, prior to being presented with the next question, and (5) submitting a resume to be associated with the responses, wherein responses and an optional resume are uploadable to the candidate database on the third-party server.

The employer interface is operatively associated with the third-party server and permits the employer to access the third-party server using an appropriate authentication and/or security protocol and a previously forwarded hyperlink to only view the candidate's responses and an optional resume stored in the candidate database by the employer selected by the candidate. The employer interface receives the responses stored in the candidate database, preferably as streaming video and audio or, alternatively, as a multimedia file from the third-party server.

### BRIEF DESCRIPTION OF THE FIGURES

FIG. 1 is a flowchart of a method for conducting a remote employment video interview in accordance with the present invention; and

FIG. 2 is a schematic of a system for conducting the remote employment interview method of FIG. 1.

### DETAILED DESCRIPTION

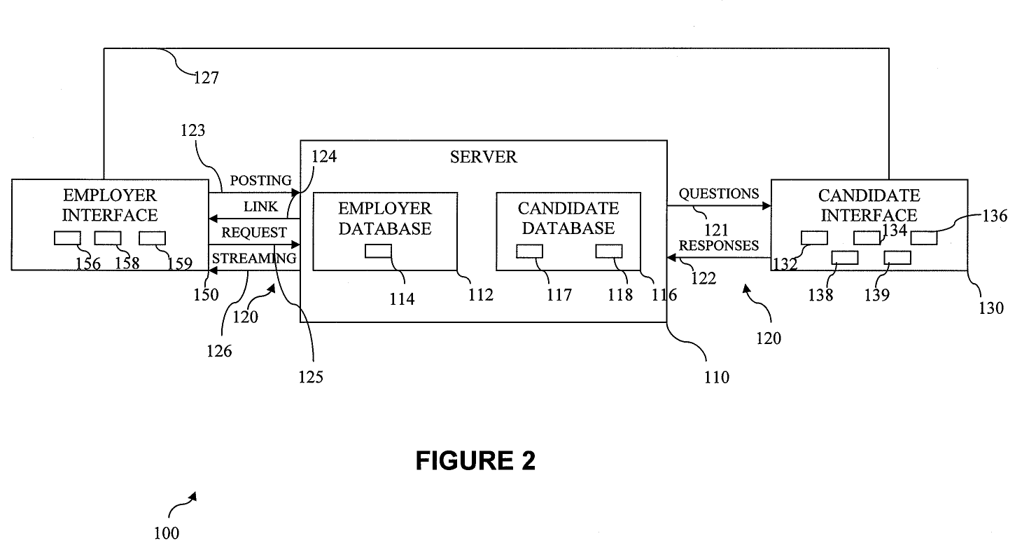

Referring now to the figures, remote employment interview method 10 can be implemented using the employment video system 100 (FIG. 2). The system 100 is divided into three main components: namely a server 110, client interface 130 and employer interface 150. The candidate interface 130 and employment interface 150 are operatively associated with the server 110 advantageously via a computer network 120, such as the Internet, or any other appropriate telecommunication system, including, but not limited to, local area networks (LANs), wide area networks (WANs), Ethernet, Wi-Fi or any other appropriate system known to one of ordinary skill in the art appropriate and consistent with the present disclosure. In addition, the candidate interface 130 and the employer interface 150 are connected to one another through network 120.

The server 110 includes an employer database 112 which includes one or more employers, each having one or more job openings or positions available. Associated with each employer position is a set of questions 114 for a candidate to respond during a remote video interview session.

The server 110 also includes a candidate database 116 which is used to store candidate data, including responses 117 to the questions associated with the employment position for a candidate to answer when applying for a respective position. In addition, the candidate database 116 includes resumes 118 submitted by candidates, which are associated with the respective candidate's responses 117 in the database 116.

The server 110 has a server interface which allows a third party, such as an employment recruiter, to maintain and act as an administrator over the system for conducting the remote employment video interview. The server interface allows the third party to modify or change questions in the set of questions 114. Further, the server interface allows the third party to review the candidate's video interview for quality assessment, such as video and audio quality, and to enhance the quality of the video or audio, as necessary, or delete the video interview if the quality is not at a desired quality level.

Further, the server interface allows the third party administrator to assign an appropriate authentication protocol which limits candidate and employer access to the server 110. For example, the server 110 can assign unique usernames and passwords for candidates and employers and only allow authorized candidates and employers access to the server 110. Further, server 110 can use the unique usernames and passwords to track which candidates access the candidate database 116 and which employers access the employer database 112. Accordingly, if an employer other than the one who receives a hyperlink to access the employer database 112 accesses the employer database, the username and password used to access the server 110 can be tracked and, optionally, the IP address of the employer interface accessing the server 110.

Further, the third party can use the server interface of server 110 to forward a link to the candidate's data to other employers not initially selected by the candidate. In addition, the server interface of server 110 allows the third party to suggest that a candidate apply for previously unlisted employment positions based on the third party's review of the candidate's interview and other employment data.

In summary, the server interface of server 110, in part, allows a third party to have administrative control and to act as a gatekeeper over the remote video interview process. The server interface protects the identity of the candidate and limits an employer's access to only specific candidate data to which a candidate wishes the employer to have access. Accordingly, the server interface of server 110 protects the identity of a candidate and limits the employers who have access. Thus, the server 110 protects confidential information from being sent ad hoc either by employers not specifically selected by the candidate or by internal employees of the third party, such as employees of an employment recruiter agency.

The candidate interface 130 includes a camera 132, microphone 134, memory 135, screen 136, speaker 138, and input device 139. The input device 139 is used by a candidate for authentication and to select one or more positions to which the candidate wishes to apply. The screen 136 displays questions 121 sent from the database of stored questions 114 to the client interface via network 120. The camera 132 and microphone 134 are used by a candidate to record his or her responses to the questions 114, which are then stored in memory 135. Prior to submitting the candidate's response, the candidate can review the response via screen 136 and speaker 138, and use input device 139 to decide whether to review, re-record, or accept and submit the response to the server 110 and to receive a next question 114 from the server 110. After the candidate has accepted a response, the response 122 is uploaded from memory 135 to server 110 and stored in the candidate database 116. Each response can be uploaded to server 110 immediately after the candidate has accepted the response or all responses can be uploaded at the conclusion of the interview.

The employer interface 150 comprises screen 156, speaker 158 and input device 159. The input device 159 is for an employer to authenticate him or herself and to access the server 110 to view the responses and an optional resume stored by a candidate after the employer has received notification, advantageously via email 124, as a reference link or hyperlink 124. Using the input device 159, the employer can make a data request 125 to the server 110 to be provided with the candidate's responses. Subsequently, the employer interface 150 receives the video responses advantageously as a stream 126 or, alternatively, as a multimedia file which can be viewed using screen 156 and heard using speaker 158. The input device 159 can also be used to post a job listing 123 on the server 110 and to submit questions to be stored in the employer database 112 and posed to a candidate during the interview process.

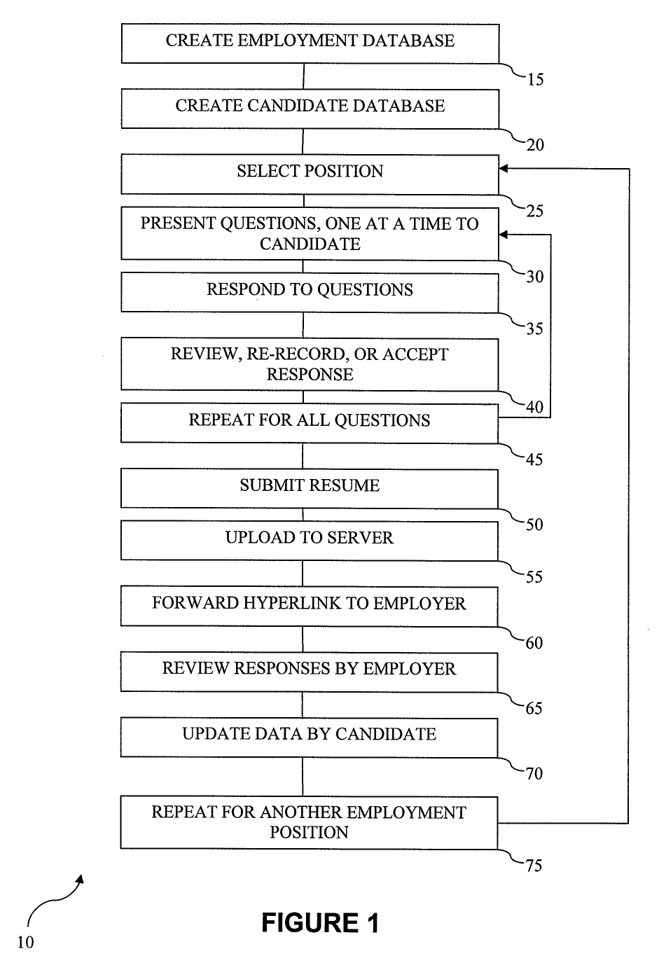

Referring now specifically to FIG. 1, along with FIG. 2, remote employment video interview method 10 can be implemented using system 100 by first creating an employment database 112 (step 15) and a candidate database 116 (step 20). A candidate for employment accesses the server 110 using an appropriate authentication protocol, such as username and password, HTTPS/IP address authentication, or any other appropriate method, for authenticating and limiting access to server 110 (step 25). The candidate is able to view the available employment positions stored in the employer database 112 (step 25). The candidate selects a position to which the candidate wishes to apply (step 25).

After the candidate selects a job position, the candidate is requested to participate in a remote video interview (step 30). The candidate is advantageously provided with instructions on how to set up and conduct a good, professional video interview. Instructions include, but are not limited to, adjusting lighting, camera angle, distance from the microphone, and other settings, in order to record a good presentation. The candidate is presented with a first question 121 from the questions 114 associated with the position to which the candidate is applying (step 30). The questions 121 are presented to the candidate on the candidate interface screen 136 as textual questions. Alternatively, the questions may be presented in the form of a video and/or audio question.

The candidate then responds to the question 121, which is recorded using the camera 130 and microphone 134 (step 35). The response is initially stored in client interface memory 135 (step 35). The candidate is then provided with the option to review the response, re-record or accept the response, using input device 139 (step 40). If the candidate selects to review the response, the previous response is displayed on screen 136 and played on speaker 138. If the candidate chooses to re-record his or her response (step 42), the previous response, stored in memory 135, is deleted or written over with the subsequent re-recorded response (step 35). This re-recording and or reviewing process can be repeated until the candidate is satisfied with the response.

Once satisfied with the response, the candidate selects to accept the response and to submit the response to the server 110 (step 40). At this point, the previously stored response in memory 135 is uploaded to the server and stored in the employee database 116 via response 122 (step 40). Alternatively, rather than uploading each response to the server 110 prior to receiving a next question 114, responses may be stored in memory 135 for submission to server 110 after the candidate has answered all questions.

After the candidate is satisfied with his or her response and has submitted the response, the candidate is presented with the next question (step 45). Steps 30-40 are repeated until all questions have been answered.

The candidate may optionally submit a resume or any other information which the candidate wishes to submit to the selected employer (step 50). The resume is then subsequently uploaded to the server 110 and stored in the candidate database 116. If the video responses have not been uploaded to the server 110, after accepting the respective responses, at step 40, all responses and the resume are uploaded to the server (step 55). The third-party administrator, using the server interface of server 110, can review the video interview for quality assessment and, if necessary or desired, enhance the video and/or audio quality or delete the video interview and request the candidate to re-record the interview (step 55).

The candidate, at any part of the interview process, can decide to suspend the interview and save any prior response so that the candidate can return at a later time to complete the interview.

After the candidate has completed the interview, the employer to whose employment position the candidate has applied is sent a hyperlink 124, advantageously via email, notifying the employer that a candidate has applied for its position and completed a video interview (step 60). The hyperlink 124 is a reference link or address to a location in the candidate database 116, where the candidate's responses and resume are located. The employer, using input device 159, selects the hyperlink 124 and, using an appropriate authentication protocol, accesses the candidate database 116, having access only to the candidate responses and optional resume corresponding to the hyperlink 124 (step 65). The employer is allowed to review the candidate's responses and resume (step 65). Further, the employer may submit additional questions 123 and contact the candidate directly via email, telephone or other telecommunications 127.

The candidate, after appropriate authentication, is allowed to access his or her submitted responses and resume stored in the candidate database 116 (step 70). Should the candidate wish to update his or her resume, include additional information, and/or delete or remove the data from the database 116, the candidate contacts the third-party, such as the employment recruiter (step 70).

At step 75, the candidate can select to apply for another position (step 75). Accordingly, steps 25-70 are repeated.

After the candidate has completed one or more video interviews, a candidate may be presented with an option of submitting his or her video interview and resume to other employers not previously selected. For example, the third party administrator may contact the candidate and suggest to the candidate that the candidate should apply to one or more other employers not first selected. Upon authorization by the candidate, the candidate's information is forwarded to the additionally selected employers as a hyperlink to the information stored on the server 110.

It will now be clear to one of ordinary skill in the art that the present remote employment video interview method 10 and system 100 provides features and advantages not found in prior employment interview methods and systems. For example, the present method and system is candidate centric, providing a candidate with complete control over his or her responses to interview questions. Unlike prior video interview methods and systems, which are rigid and prevent a candidate from having control over the interview process, the present method is flexible and allows a candidate to have control over the interview process. Having control over the interview is exceedingly important in order to accommodate a lack of uniformity and consistency among computer equipment and telecommunication devices, including computer video, camera, microphones and other associated equipment, all of which thwart the goal of creating a consistent and good video presentation. Unfortunately, however, prior methods do not accommodate such inconsistencies and do not allow a candidate to adjust his or her equipment in order to prepare a good presentation. Further, prior methods to not permit a candidate to review and re-record responses to interview questions prior to submitting responses. However, in the present method and system, a candidate is provided with instructions on how to produce a good video interview. Moreover, a candidate is provided with an opportunity now to review his or her responses and to re-record his or her response until he or she is satisfied with the quality and content of the response. One advantage of the current feature is that both the candidate and the employer benefit from the present method, namely the candidate has the opportunity to prepare a good presentation which is representative of the candidate, and the employer benefits by reviewing a good quality representation of the candidate without the artifacts of a poor video interview, which would likely occur without the present system, which accommodates and allows a candidate to adapt to the telecommunication configuration.

In addition, unlike prior video interview systems, an employer does not have to be intimately involved during the actual interview itself. However, the employer can prepare and generate questions which the employer wishes a candidate to answer in advance of the interview. These questions are stored on the server and provided to the candidate during the actual interview itself.

In addition, a further feature of the present method is that the candidate selects only the employers he or she wishes to submit his or her interview. Again, this feature empowers a candidate to have control over the employment application process.

Yet a further feature of the present invention is provided, using a central third-party server which stores and maintains large audio-video files corresponding to the responses of the candidate. Then, the responses are sent to the selected employer as a streaming video. As a result, the employer does not receive an email with a relatively large audio-video file corresponding to the responses to the questions, but merely a hyperlink to where the data is stored in the third-party server.

Yet another feature of the present invention is provided by using a secured authentication protocol to limit an employer and a candidate to only specific data stored in the server 110.

In yet another feature of the present invention, a third party, using the server interface, acts as an administrator or gatekeeper to maintain and secure confidential information of a candidate and to limit both candidates and employers who have access to the server. As a result, the identity of a candidate is limited to only employers specifically selected by the candidate. In addition, the server allows the third party to track and to know who accesses the server by using secure authentication protocols.

Although the invention has been described above in relation to preferred embodiments thereof, it will be understood by those skilled in the art that variations and modifications can be effected in these preferred embodiments without departing from the scope and spirit of the invention.

1. A method for conducting an interview of a candidate for employment, said method comprising:
creating a database comprising one or more employment positions for one or more employers on a third-party server;
allowing a candidate to select an employment position for which to apply;
providing a candidate, via a computer network, with one or more questions, stored on the third party server, for a candidate to respond, one question at a time, pertaining to the position selected by the candidate;
allowing the candidate to respond to each question, one at a time, as a video and audio response;
allowing the candidate to review, re-record, delete and accept the prior response, prior to being presented with a next question;
storing all responses on the third-party server;
providing the candidate with the option of submitting his or her resume to be associated with the responses, and storing the optional resume on the third party server;
forwarding a reference link, via email, to the employer whose employment position was selected by the candidate, the reference link corresponding to a location on the third-party server where the candidate's responses and optional resume are stored; and
permitting the employer to access the third-party server via an appropriate security protocol, using the reference link to view the candidate's responses and optional resume, the responses being sent to the employer as streaming video and audio or as a multimedia file.

2. The method of claim 1, further comprising providing a candidate with instructions for conducting a good computer-implemented video interview.

3. The method of claim 1, wherein the one or more questions are presented to the candidate as textual questions.

4. The method of claim 1, wherein said storing the responses comprises receiving the responses from the candidate, one at a time, after responding to a respective question, which responses are uploaded to the server after the candidate is satisfied.

5. The method of claim 1, further comprising receiving responses from the candidate, one at a time, after the candidate is satisfied, which responses are uploaded from the candidate to the third-party server.

6. The method of claim 1, wherein said allowing the candidate to review, re-record, delete and accept the prior response, prior to being present with a next question, comprises:
presenting the candidate with options to select to: (i) review the response; (ii) re-record the response; and (iii) accept the response and move on to the next question; and
allowing the candidate to select one of the options.

7. The method of claim 1, wherein storing all responses on the third-party server comprises storing all responses together with an optional resume in a database, and associating the responses and the optional resume with the candidate.

8. A system for conducting an interview of a candidate for employment, said system comprising:
a third party server;
an employment database maintained on the third-party server, the employment database comprising one or more employment positions for one or more employers, and one or more interview questions associated with a respective employment position;
a candidate database maintained on the third-party server for storing candidate data comprising candidate responses to the employment questions and an optional resume;
a candidate interface operatively associated with the third-party server, the candidate interface comprising a camera and a microphone for recording video and audio, the candidate interface for:
(i) allowing the candidate to select one of the employment positions to apply,
(ii) presenting the candidate, via a computer network, with one or more questions, stored on the third party server, for a candidate to respond, one question at a time, pertaining to an employment position selected by the candidate,
(iii) allowing the candidate to respond to each question, one at a time, as a video and audio response,
(iv) allowing the candidate to review, re-record, delete and accept the prior response, prior to being presented with a next question, and
(v) submitting a resume to be associated with the responses; and
an employer interface operatively associated with the third-party server; the employer interface permitting the employer to access the third-party server using an appropriate security protocol, and a hyperlink to only view candidate's responses and an optional resume, stored in the candidate database, by an employer whose employment position was selected by the candidate, the employer interface receiving the responses stored in the candidate database as streaming video and audio or as a multimedia file from the third-party server.

9. The system of claim 8, wherein the candidate interface comprises a client side video and audio communication system.

10. The system of claim 8, wherein the employment database comprises questions stored in textual form.

11. The system of claim 8, wherein the candidate interface includes options for a candidate to: (i) review a response; (ii) re-record a response; and (iii) accept a response and move on to the next question.
